(19) United States
(12) Patent Application Publication
(10) Pub. No.: US 2009/0128880 A1
(43) Pub. Date: May 21, 2009

(54) LIGHT CONTROLLING APPARATUS

(75) Inventor: Tatsuhiko OKITA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/272,431

(22) Filed: Nov. 17, 2008

(30) Foreign Application Priority Data
Nov. 20, 2007 (JP) 2007-300467

(51) Int. Cl. G02B 26/02

(52) U.S. Cl. 359/230; 359/233

(57) ABSTRACT

In a light controlling apparatus including a substrate in which an aperture is formed, a light controlling unit in which, another aperture is formed, and a ion conducting actuator as a driving source, the aperture formed in the substrate and the aperture formed in the light controlling unit are switched by moving the light controlling unit to a first stationary position which overlaps with a position of the aperture formed in the substrate, and a second stationary position which is a position retracted from the position of the aperture formed in the substrate, by changing a shape of the ion conducting actuator by supplying an electric power to the ion conducting actuator. The light controlling apparatus further includes a magnet, and when the light controlling unit has moved to one of the first stationary position and the second stationary position, the power supply to the ion conducting actuator is stopped, and by a magnetic force of the magnet, the light controlling unit is held at one of the first stationary position and the second stationary position.

### CROSS-REFERENCE TO RELATED APPLICATION

The present application is based upon and claims the benefit of priority from the prior Japanese Patent Application No. 2007-300467 filed on Nov. 20, 2008; the entire contents of which are incorporated herein by reference.

### BACKGROUND OF THE INVENTION

1. Field of the Invention

The present invention relates to a light controlling apparatus, and particularly, to a light controlling apparatus which is suitable for use in a small-size optical apparatus such as a portable equipment and a micro videoscope having an image pickup function.

2. Description of the Related Art

In recent years, there has been an improvement in performance of small size-optical apparatuses such as portable equipments and micro videoscopes having an image pickup function. With this improvement, even for optical elements such as a lens and an aperture, there has been an increasing demand for application of a focus lens and a variable aperture instead of a conventional fixed focus lens and a fixed aperture stop. With the decrease in the size of an optical apparatus, there has been an active development of actuators which drive the optical element which is used, and driving methods in which various actuators are used have been proposed.

Particularly, a ion conducting actuator is an actuator which is deformed by bending by applying a voltage, upon forming an electrode on a surface of an ion-exchange resin in the state of including polar molecules such as an ion fluid. This ion conducting actuator which is called as an artificial muscle for its flexible drive mode is expected to have an application in a focus lens and a variable aperture, and the research of this ion conducting actuator has been carried forward. However, a control of an amount of displacement with respect to a voltage being difficult for the ion conducting actuator, an application of the ion conducting actuator in an optical element in which a highly precise position control is sought, has been considered to be unsuitable.

In order to solve such problems, a ion conducting actuator as shown in FIG. 13, which drives an optical element is used in Japanese Patent Application Laid-open Publication No. 2006-301203. Moreover, a small-size optical apparatus which is capable of carrying out a highly precise position control of an optical element has been proposed. In FIG. 13, an image pickup unit 10 includes a lens group 11 which forms an optical image of an object, a movable lens frame 12 which holds the lens group 11, guide shafts 13a and 13b which movably support the movable lens frame 12, a movable plate 14 which is movable along the guide shafts 13a and 13b, a lid member 16 and a fixed lens frame 15 which hold the guide shafts 13a and 13b, a coil spring 17 which applies bias on the movable lens frame 12 and the movable plate 14, toward the fixed lens frame 15, a ion conducting actuator 18 which moves the movable lens frame 12 with respect to the movable plate 14, toward the lid member 16, a ion conducting actuator 19 which moves the movable plate 14 toward the lid member 16, an image pickup element 20, and a substrate 21 which holds the image pickup element 20. The ion conducting actuators 18 and 19 are driven independently.

The highly precise position control of an optical element has become possible by a structure disclosed in Japanese Patent Application Laid-open Publication No. 2006-301203. However, in this structure, even in a case of holding an optical element at a predetermined stationary position, it is necessary to supply an electric power to the actuator. Therefore, even when an optical element to be driven is not being displaced, an electric power is consumed, which is a wasteful consumption of electric power.

Moreover, when the ion conducting actuator is used, by supplying the electric power repeatedly, there is a possibility that the amount of displacement is decreased. A tendency of a decrease in the amount of displacement is particularly remarkable when an attempt is made to achieve a substantial amount of displacement by applying a high voltage.

### SUMMARY OF THE INVENTION

The present invention is made in view of the abovementioned circumstances, and an object of the present invention is to provide a light controlling apparatus which is capable of suppressing an electric power consumption and simultaneously reducing a decrease in an amount of displacement of a ion conducting actuator, while carrying out a highly precise position control of an optical element.

To solve the abovementioned issues, and to achieve the object, according to the present invention, it is possible to provide a light controlling apparatus including

a substrate in which, an aperture is formed,

a light controlling unit in which, another aperture is formed, and

a ion conducting actuator as a driving source, and

the aperture formed in the substrate and the aperture formed in the light controlling unit are switched by moving the light controlling unit to a first stationary position which overlaps with a position of the aperture formed in the substrate, and a second stationary position which is a position retracted from the position of the aperture formed in the substrate, by changing a shape of the ion conducting actuator by supplying an electric power to the ion conducting actuator, and further including

a magnet, and

when the light controlling unit has moved to one of the first stationary position and the second stationary position, the power supply to the ion conducting actuator is stopped, and by a magnetic force of the magnet, the light controlling unit is held at one of the first stationary position and the second stationary position.

Moreover, according to a preferable aspect of the present invention, it is desirable that the ion conducting actuator has a circular arc shape, and the light controlling unit is displaced by changing a chord length of the ion conducting actuator by supplying the electric power to the ion conducting actuator.

According to a preferable aspect of the present invention, it is desirable that when the light controlling unit is being displaced, the magnet serves as a stopper which stops the light controlling unit at one of the first stationary position and the second stationary position.

Moreover, according to a preferable aspect of the present invention, it is desirable that at least one of a drive shaft of the light controlling unit and a connecting member coupled with ion conducting actuator is formed of a magnetic body, and

a pair of magnets is disposed near both end portions of a range of movement of the drive shaft and the connecting member coupled with the ion conducting actuator, and

when the light controlling unit has moved to one of the first stationary position and the second stationary position, the drive shaft of the light controlling unit and the connecting member are held at that stationary position by a magnetic force of one of the pair of magnets.

Moreover, according to a preferable aspect of the present invention, it is desirable that the light controlling unit is formed of a magnetic body, and a pair of magnets is disposed near both end portions of a range of movement of the light controlling unit, and

when the light controlling unit has stopped at one of the first stationary position and the second stationary position, the light controlling unit formed of the magnetic body is held at that stationary position by a magnetic force of one of the pair of magnets.

Moreover, according to a preferable aspect of the present invention, it is desirable that at least one of the light controlling unit, the drive shaft, and the connecting member coupled with the ion conducting actuator is formed of a magnetic body, and

a magnet in a form of a thin plate is disposed to be facing the magnetic body, leaving a gap in a direction of an optical axis of the light controlling apparatus, and

the light controlling unit is displaced by a displacement of the ion conducting actuator, and

when the electric power is not being supplied to the ion conducting actuator, the position of the light controlling unit is held resisting a restoring force of the ion conducting actuator, by a magnetic force of the magnetic body and the magnet in the form of a thin plate.

Moreover, according to a preferable aspect of the present invention, it is desirable that at least one of the light controlling unit, the drive shaft, and the connecting member coupled with the ion conducting actuator is formed of a first magnetic body, and

a magnet in a form of a thin plate is disposed via a second magnetic body around which a coil is wound, facing the first magnetic body, leaving a gap in a direction of an optical axis of the light controlling apparatus, and

when the light controlling unit is displaced, an electric current in a direction negating the magnetic power of the magnet in the form of a thin plate is passed through the coil, and when the light controlling unit is stationary, the position of the light controlling unit is held resisting a restoring force of the ion conducting actuator, by a magnetic force of the first magnetic body and the magnet in the form of a thin plate.

### BRIEF DESCRIPTION OF THE DRAWINGS

FIG. 1 is an exploded view of a light controlling apparatus according to a first embodiment of the present invention;

FIG. 2 is an assembly diagram of the light controlling apparatus according to the first embodiment;

FIG. 3 is a diagram describing an operation of a ion conducting actuator;

FIG. 4 is a top view of the first embodiment;

FIG. 5 is a diagram describing a first stationary position of the first embodiment;

FIG. 6 is a diagram describing a second stationary position of the first embodiment;

FIG. 7 is a top view of a second embodiment of the present invention;

FIG. 8 is a diagram describing a first stationary position of the second embodiment;

FIG. 9 is a diagram describing a second stationary position of the second embodiment;

FIG. 10 is a perspective view of a third embodiment of the present invention;

FIG. 11 is a diagram describing a structure according to a fourth embodiment of the present invention;

FIG. 12 is a side view of the fourth embodiment; and

FIG. 13 is a diagram describing a structure of a conventional light controlling apparatus.

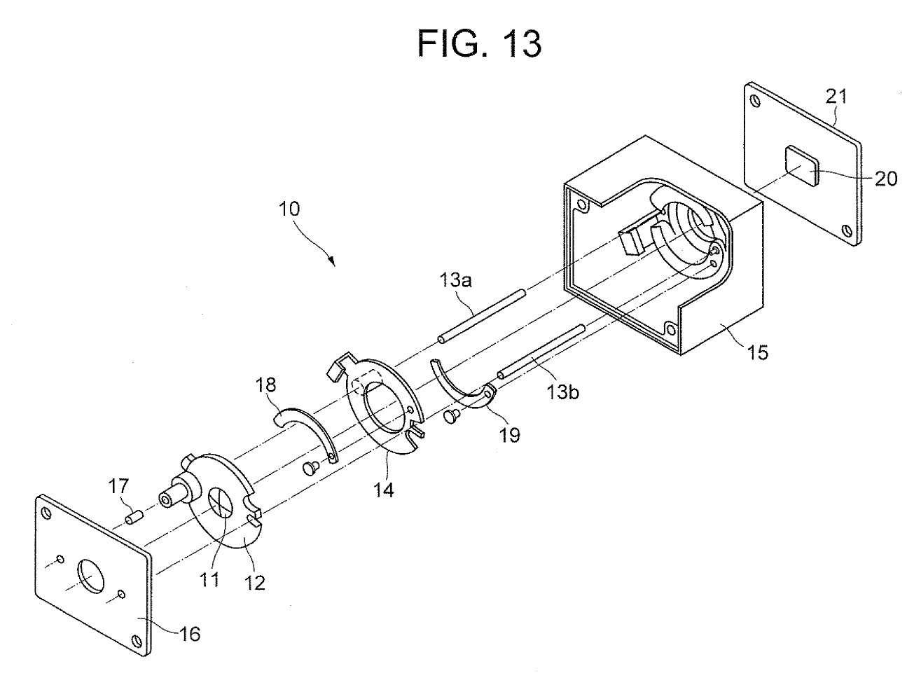

### DETAILED DESCRIPTION OF THE PREFERRED EMBODIMENTS

Embodiments of a light controlling apparatus according to the present invention will be described below in detail by referring to the accompanying diagrams. However, the present invention is not restricted to the embodiments described below.

### First Embodiment

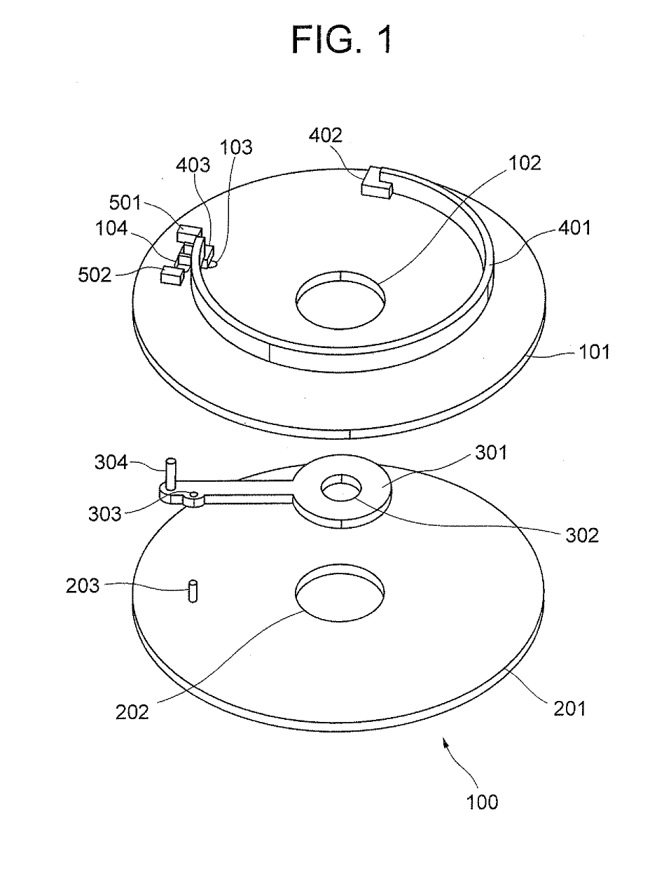

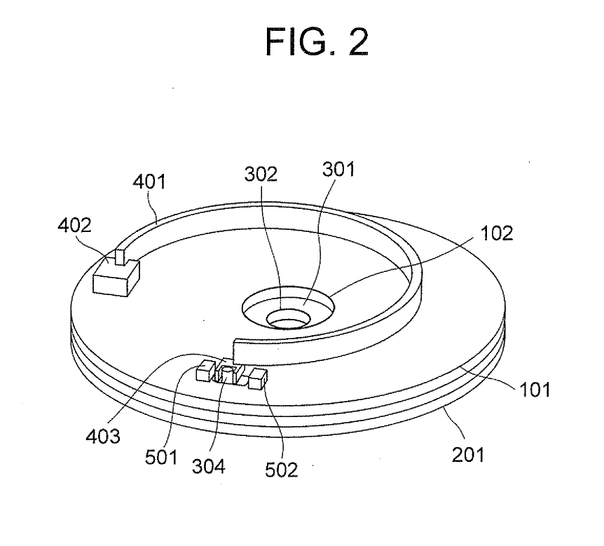

A first embodiment will be described by using diagrams from FIG. 1 to FIG. 6. Firstly, a structure of a light controlling apparatus 100 of the first embodiment will be described below by using FIG. 1 and FIG. 2. FIG. 1 shows an exploded view of the light controlling apparatus 100, and FIG. 2 shows an assembly diagram of the light controlling apparatus 100. As shown in FIG. 1, the light controlling apparatus 100 includes a first substrate 101, a second substrate 201, and a light controlling unit 301.

A first aperture 102, a rotating shaft hole 103, and a drive shaft hole 104 are formed in the first substrate 101, and magnets 501 and 502 are disposed face-to-face near both ends of the drive shaft hole 104. Moreover, an electrode 402 fixed by sticking on the substrate 101, a ion conducting actuator 401 fixed to the electrode 402, and a connecting member 403 fixed by sticking to a front end of the ion conducting actuator 401 are provided on the first substrate 101. A second aperture 202 and a rotating shaft 203 are formed in the second substrate 201. A rotating shaft hole 303, a drive shaft 304, and a third aperture 302 smaller than the first aperture 102 and the second aperture 202 are formed in the light controlling unit 301.

The rotating shaft 203 is inserted through the rotating shaft hole 103 of the first substrate 101 via the rotating shaft hole 303 of the light controlling unit 301. As shown in FIG. 2, the drive shaft 304 is coupled with the ion conducting actuator 401 by the connecting member 403 via the drive shaft hole 104.

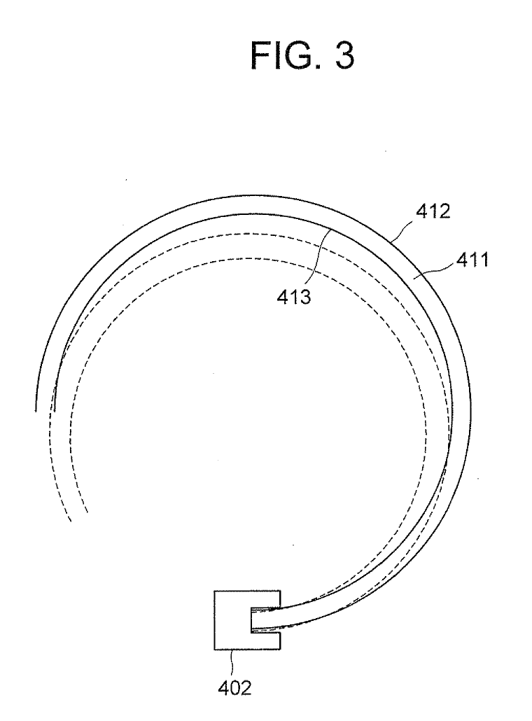

Next, details of an actuator portion will be described below by referring to FIG. 3. The circular arc shaped ion conducting actuator 401 having electrodes formed on both surfaces which are face-to-face has a three-layered structure of an ion-containing polymer 411 which is a circular arc shaped substrate, a first electrode 412 provided on a surface at an outer side of the circular arc, and a second electrode 413 provided on a surface facing the first electrode.

An electric potential difference is generated between the first electrode 412 and the second electrode 413 by outputting a voltage from an external voltage source (not shown in the diagram). Cations (positive ions) of the ion-containing polymer 411 move toward a cathode side. As a result of this, a cathode side of the ion-containing polymer 411 is swollen, and the chord length changes due to a change in a curvature of the circular arc shape as shown by dashed lines in FIG. 3. In this manner, it is possible to change within a predetermined range, the chord length of the ion conducting actuator 401 by an output voltage of the external voltage source.

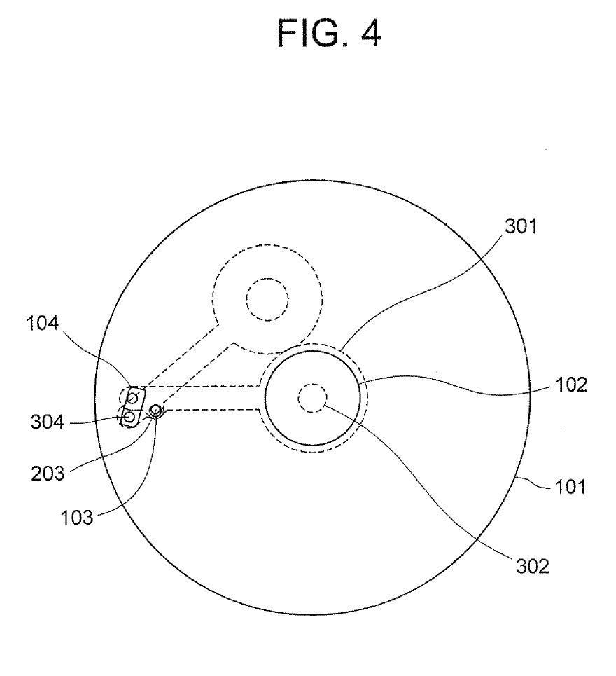

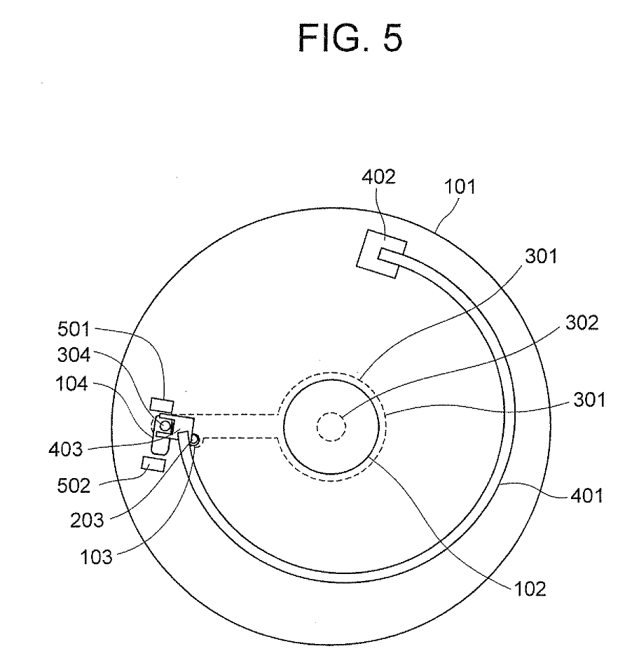

Each component will be described below in detail. FIG. 4 and FIG. 5 show a top view of the light controlling apparatus 100, where, FIG. 4 is a diagram in which, the ion conducting actuator 401, and the magnets 501 and 502 are omitted.

As shown in FIG. 5, a diameter of the rotating shaft hole 103 formed in the first substrate 101 is set to be slightly larger than a diameter of the rotating shaft 203. Moreover, the drive shaft hole 104 has a width slightly larger than a diameter of the drive shaft 304, and forms a groove so that the drive shaft 304 is movable around the rotating shaft 203, in a direction facing the magnets 501 and 502.

Moreover, as shown in FIG. 1, a diameter of the second aperture 202 of the second substrate 201 is set to be same as or slightly larger than a diameter of the first aperture 102 of the first substrate 101. Further, as shown in FIG. 4, the light controlling unit 301 is structured to be rotatable around the rotating shaft 203 as an axis of rotation. The light controlling unit 301 is rotated by a movement of the drive shaft 304. Accordingly, an aperture diameter regulated by the first aperture 102 and the third aperture 302 is switched. As a result of this, it functions as a variable aperture which switches an aperture diameter of the light controlling apparatus. Moreover, the connecting member 403 is formed of a magnetic body.

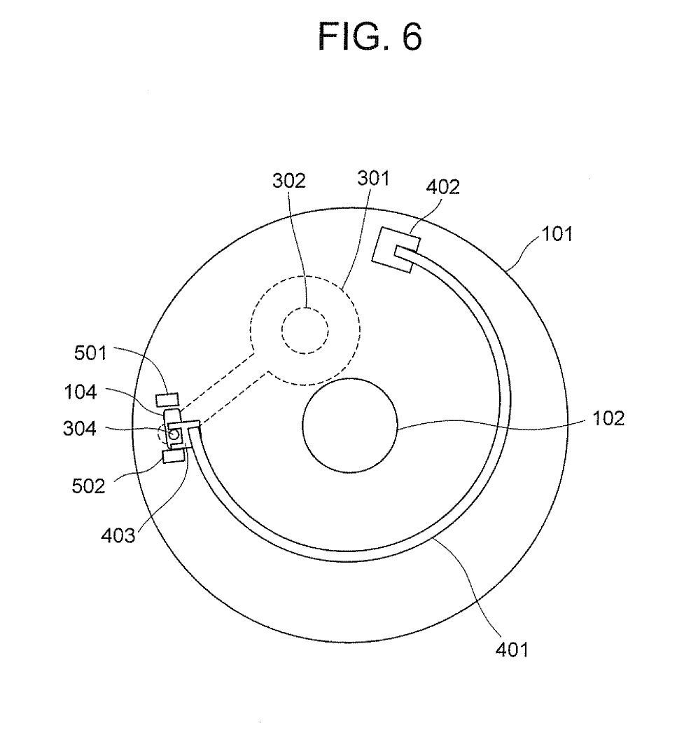

An operation of the light controlling apparatus 100 of the first embodiment will be described by using FIG. 5 and FIG. 6. FIG. 5 and FIG. 6 show a top view of the light controlling apparatus 100. As shown in FIG. 5 and FIG. 6, by supplying an electric power to the electrode 402, a curvature of the circular arc shape of the ion conducting actuator 401 is changed, and as a result of this, the ion conducting actuator 401 is displaced. When the connecting member 403 made of a magnetic body is abut against the magnet 501, the light controlling unit 301 moves to a first stationary position at which the third aperture 302 and the first aperture 102 overlap, and stops. At this time, the third aperture 302 becomes the aperture of the light controlling apparatus 100.

Whereas, when the connecting member 403 is abut against the magnet 502, the light controlling unit 301 moves to a second stationary position at which, the third aperture 302 has retracted completely from the first aperture 102, and stops. At this time, the first aperture 102 becomes the aperture of the light controlling apparatus 100.

FIG. 5 is a diagram showing a state of the light controlling unit 301 in the light controlling apparatus 100, at the first stationary position overlapping with the first aperture 102. In this state, the electric power is not supplied to the ion conducting actuator 401, and the light controlling unit 301 has the connecting member 403 made of a magnetic body held at the first stationary position by a magnetic force of the magnet 501. The curvature of the ion conducting actuator 401 changes according to the supply of electric power, and the ion conducting actuator 401 is displaced.

Accordingly, the connecting member 403 which is connected to the ion conducting actuator 401 moves the drive shaft 304 along a groove of the drive shaft hole 104, and the light controlling unit 301 rotates around the rotating shaft 203 as a center. Moreover, the connecting member 403 made of a magnetic body is abut against the magnet 502, and the light controlling unit 301 stops at a second stationary position as shown in FIG. 6. At this time, the supply of electric power to the ion conducting actuator 401 is stopped. The connecting member 403 made of a magnetic body is held at the second stationary position by the magnetic force of the magnet 502.

In the first embodiment, the description was made upon letting an initial position of the light controlling unit 301 to be the first stationary position. However, it is similar even when the initial position is the second stationary position. Moreover, it is possible to achieve an effect similar to the effect described above even when the components of the first embodiment are changed as follows.

In other words, instead of the connecting member 403 being formed of a magnetic body, even when the drive shaft 304 is let to be a component formed of a magnetic body, the similar effect is achieved. Furthermore, even by letting the magnets 501 and 502 disposed near both ends of the drive shaft hole 104 to be magnetic bodies, and by forming the drive shaft 304 or the connecting member 403 of a magnet, the similar effect is achieved.

In this manner, in the first embodiment, regarding the switching of the light controlling unit 301, by holding the connecting member 403 made of a magnetic body, or the drive shaft 304 made of a magnetic body by a magnet, it is possible to hold the light controlling unit 301 at a predetermined position. Consequently, the electric power is supplied to the ion conducting actuator 401 only at the time of switching the light controlling unit 301, and for holding the light controlling unit 301 at the predetermined position it is not necessary to supply the electric power to the ion conducting actuator 401. Accordingly, it is possible to reduce a wasteful consumption of electric power, and to reduce a decrease in an amount of displacement which may be caused due to supplying the electric power to the ion conducting actuator 401 all the time.

Since the pair of magnets 501 and 502 shown in the first embodiment also serves as a stopper which controls the movement of the connecting member 403, it also has a function of stopping the light controlling unit 301 at a predetermined position.

### Second Embodiment

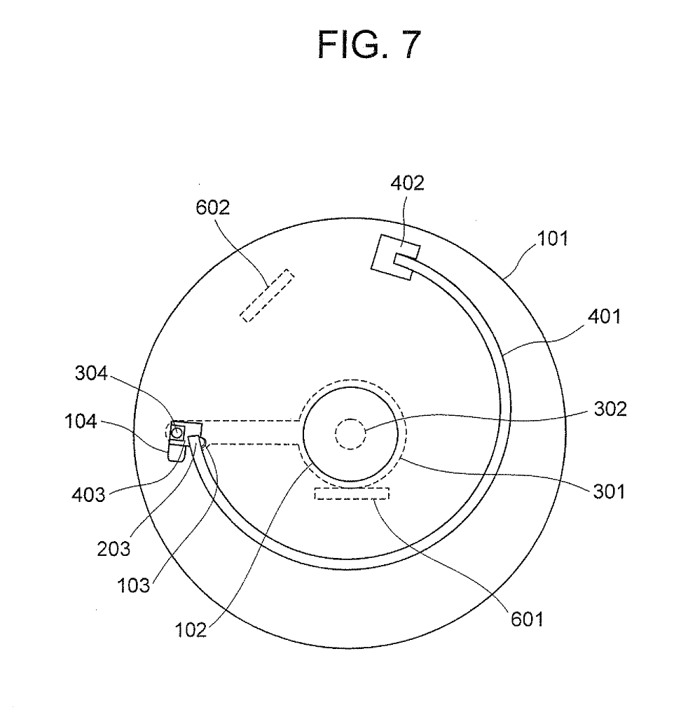

Next, a second embodiment of the present invention will be described below by using FIG. 7 to FIG. 9. Same reference numerals are assigned to components same as in the first embodiment, and the description to be repeated is omitted.

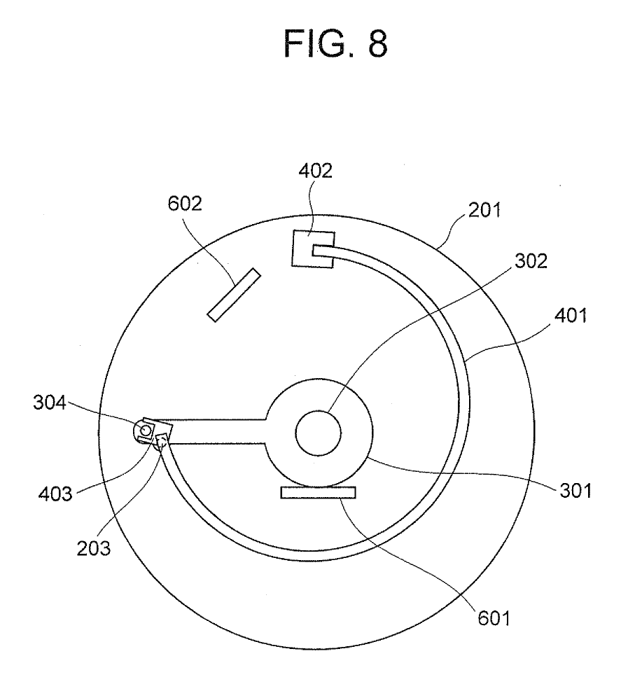

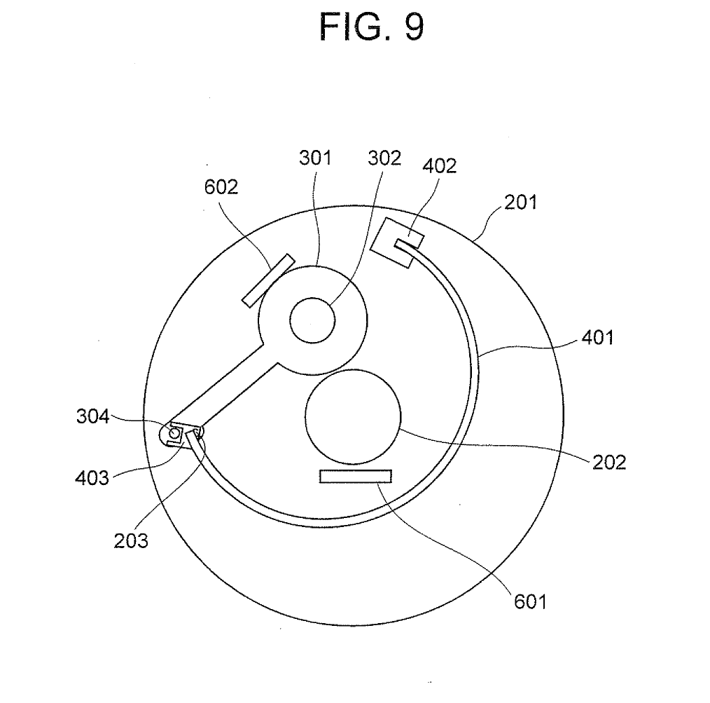

FIG. 7 is a top view of a light controlling apparatus, and FIG. 8 and FIG. 9 are top views in which the first substrate 101 is omitted from the light controlling apparatus to make it easy to see a position and an operation of the light controlling unit 301. As shown in FIG. 7, in the second embodiment, the magnets 501 and 502 in the first embodiment are removed. Moreover, magnets 601 and 602 are disposed on the second substrate 201 as shown in FIG. 8 and FIG. 9. A thickness of the magnets 601 and 602 is the same, and is more than a thickness of the light controlling unit 301.

As shown in FIG. 8, the magnet 601 is disposed such that the light controlling unit 301 is abut against the magnet 601 and stops at the first stationary position. The magnet 602 is disposed such that, the light controlling unit 301 is abut against the magnet 602 and stops at the second stationary position. Moreover, in the second embodiment, the light controlling unit 301 is formed of a magnetic body.

An operation of the light controlling apparatus of the second embodiment will be described by using diagrams from FIG. 7 to FIG. 9. FIG. 8 is a diagram showing a state when the light controlling unit 301 of the light controlling apparatus is at the first stationary position which overlaps with the first aperture. In this state, the electric power is not supplied to the ion conducting actuator 401, and the light controlling unit 301 made of a magnetic body is held at the first stationary position by the magnetic force of the magnet 601. The curvature of the ion conducting actuator 401 changes according to the supply of electric power, and the ion conducting actuator 401 is displaced.

Accordingly, the connecting member 403 which is connected to the ion conducting actuator 401 moves the drive shaft 304 along the groove of the drive shaft hole 104. The light controlling unit 301 rotates around the rotating shaft 203 as a center. Moreover, the light controlling unit 301 made of a magnetic body is abut against the magnet 602, and stops at the second stationary position as shown in FIG. 9. At this time, the supply of electric power to the ion conducting actuator 401 is stopped. The light controlling unit 301 made of a magnetic body is held at the second stationary position by the magnetic force of the magnet 602.

The thickness of the magnets 601 and 602 being more than the thickness of the light controlling unit 301, the magnets 601 and 602 serve as a spacer for the first substrate 101 and the second substrate 201, and the light controlling unit 301, and there is no difficulty in the operation of the light controlling unit 301, due to the light controlling unit 301 being sandwiched between the first substrate 101 and the second substrate 201.

Even in the second embodiment, the description was made upon letting the initial position of the light controlling unit 301 to be the first stationary position. However, it is similar even when the initial position is the second stationary position. Moreover, in the second embodiment, the light controlling unit 301 is formed of a magnetic body. However, even when the magnets 601 and 602 are formed of a magnetic body, and the light controlling unit 301 is formed of a magnet, the similar effect is achieved.

In the second embodiment, similarly as a merit of the first embodiment, since it is possible to hold the light controlling unit 301 at the predetermined position without supplying the electric power to the ion conducting actuator 401, it is possible to suppress the electric power consumption, and to reduce a decrease in the amount of displacement of the ion conducting actuator 401 which may be caused due to supplying the electric power all the time.

In the second embodiment, unlike in the first embodiment, the magnets 601 and 602 are disposed between the first substrate 101 and the second substrate 201. Therefore, the magnets 601 and 602 have a function as a spacer between the two substrates, and it is not necessary to dispose separate spacers. Furthermore, since it is not necessary to dispose the magnet on the first substrate 101, it is possible to have a wide space on the first substrate, and there is an increase in a degree of freedom of designing such as an arrangement of the actuator.

### Third Embodiment

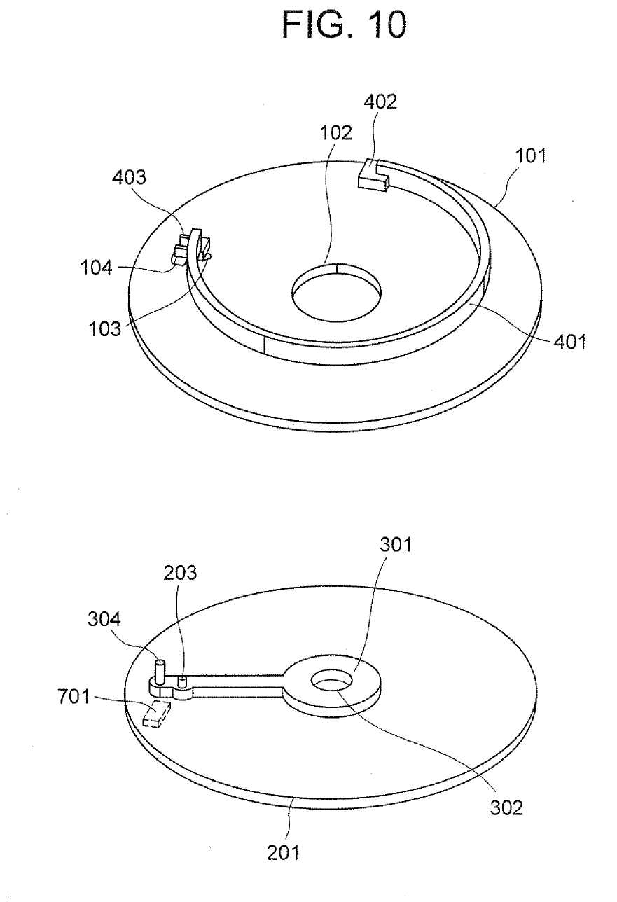

Next, a third embodiment of the present invention will be described below by using FIG. 10. FIG. 10 is a perspective view of a light controlling apparatus of the third embodiment In order to make it easy to see each component, the first substrate 101 and the second substrate 201 are shown to be dismantled. Same reference numerals are assigned to components which are same as in the first embodiment and the second embodiment, and the description to be repeated is omitted.

In the third embodiment, a magnet 701 in the form of a thin plate is disposed on a rear surface of the second substrate 201. The magnet 701 is fixed by adhering at a position facing the drive shaft hole 104 formed in the first substrate 101 as shown in FIG. 10. Moreover, although it is not shown in the diagram, when the drive shaft 304 has moved to one of the end portions of the drive shaft hole 104, the light controlling unit 301 moves to the first stationary position and the second stationary position. Furthermore, in the third embodiment, the connecting member 403 is made of a magnetic body. The connecting member 403 is under an effect of magnetic power of the magnet 701 all the time, and the driving force of the connecting member 403 by the ion conducting actuator 401 is set to be stronger than the magnetic force of the magnet 701.

FIG. 10 is a diagram showing a state when the light controlling unit 301 in the light controlling apparatus is at the first stationary position which overlaps with the first aperture 102. In this state, the electric power is not supplied to the ion conducting actuator 401. The connecting member 403 made of a magnetic body is held at the first stationary position by the magnetic force of the magnet 701 disposed on the rear surface of the second substrate 201. The curvature of the ion conducting actuator 401 changes according to the supply of electric power, and the ion conducting actuator 401 is displaced.

Accordingly, the connecting member 403 made of a magnetic body which is connected to the ion conducting actuator 401 moves the drive shaft 304 along the groove of the drive shaft hole 104, to one end portion of the drive shaft hole 104. Accordingly, the light controlling unit 301 rotates around the rotating shaft 203 as a center. Moreover, the drive shaft 304 moves to the end portion of the drive shaft hole 104, and the light controlling unit 301 stops at the second stationary position which is a position retracted from the first aperture 102 formed in the first substrate 101. At this time, the supply of the electric power to the ion conducting actuator 401 is stopped according to the stoppage. The connecting member 403 made of a magnetic body is held at the second stationary position, resisting the restoring force of the ion conducting actuator 401 by the magnetic power of the magnet 701.

Even in the third embodiment, similarly as in the first embodiment and the second embodiment, the description was made upon letting the initial position of the light controlling unit 301 to be the first stationary position. However, it is similar even when the initial position is the second stationary position. Moreover, in the third embodiment, the description was made by assuming the connecting member 403 to be a magnetic body. However, it is possible to achieve a similar effect even when the drive shaft 304 is formed of a magnetic body. Furthermore, it is possible to achieve the similar effect even when the magnet 701 is let to be a magnetic body, and the connecting member 403 or the drive shaft 304 is formed of a magnet.

As a merit of the third embodiment, similarly as a merit of the first embodiment and the second embodiment, it is possible to hold the light controlling unit 301 at a predetermined position without supplying the electric power to the ion conducting actuator 401. Therefore, it is possible to suppress the electric power consumption, and to reduce a decrease in the amount of displacement of the ion conducting actuator 401 which may be caused due to supplying the electric power all the time.

Moreover, in the third embodiment, unlike in the first embodiment and the second embodiment, the magnet 701 is disposed on the rear surface of the second substrate 201 on which, no other component is provided. Therefore, it is possible to fix by adhering the magnet comparatively easily. Moreover, similarly as the second embodiment, it is possible to have a wide space on the first substrate, and there is an increase in the degree of freedom of designing such as an arrangement of the actuator.

### Fourth Embodiment

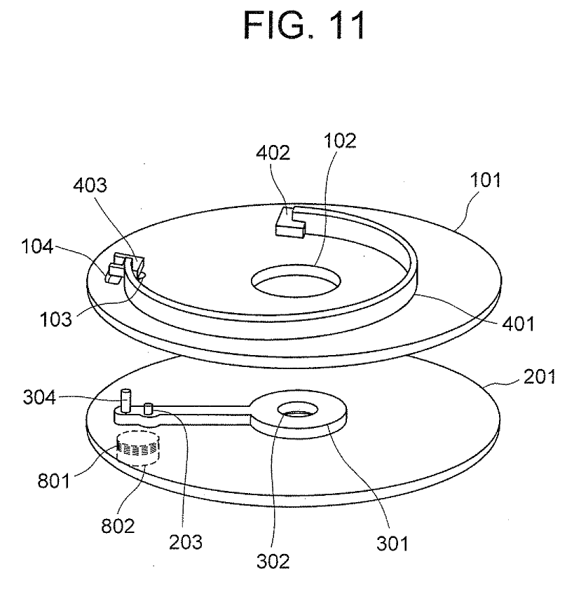

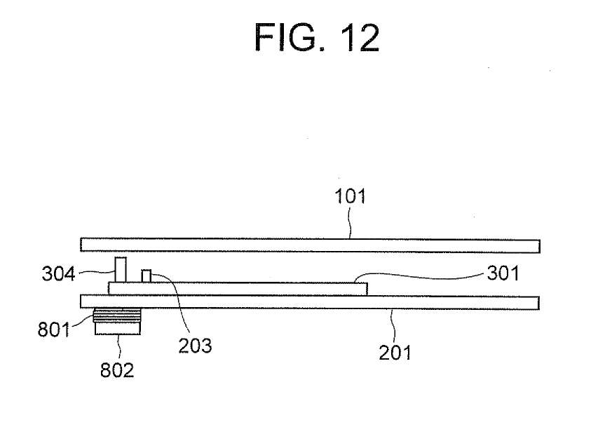

Next, a light controlling apparatus according to a fourth embodiment of the present invention will be described below by using FIG. 11 and FIG. 12. Same reference numerals are assigned to components same as in each of the embodiments described above, and the description to be repeated is omitted. FIG. 11 shows a state in which the first substrate 101 and the second substrate 201 are dismantled, and FIG. 12 shows a state seen from a side, without showing components disposed on the first substrate 101 for making it easy to see the structure.

A structure of the light controlling apparatus of the fourth embodiment will be described below. In the fourth embodiment, a magnetic 802 is disposed on the rear surface of the second substrate 201, via a magnetic body 801 having a coil wound around. The magnetic body 801 having the coil wound around and the magnet 802 are fixed by adhering at a position facing the drive shaft hole 104 formed in the first substrate 101 as shown in FIG. 11. Moreover, although it is not shown in detail in the diagram, when the drive shaft 304 has moved to one of the end portions of the drive shaft hole 104, the light controlling unit 301 moves to the second stationary position. Moreover, in the fourth embodiment, the connecting member 403 is made of a magnetic body.

FIG. 11 is a diagram showing a state when the light controlling unit 301 in the light controlling apparatus is at the first stationary position which overlaps with the first aperture 102. In this state, the electric power is not supplied to the ion conducting actuator 401. The connecting member 403 made of a magnetic body is held at the first stationary position by the magnetic force of the magnet 802 disposed on the rear surface of the second substrate 201. Here, an electric current is passed through the coil of the magnetic body 801, and the magnetic power of the magnet 802 is negated. A direction of the electric current to be passed through the coil is set in advance to a direction which negates the magnetic force of the magnet 802.

In this state, by supplying the electric power to the ion conducting actuator 401, the curvature of the ion conducting actuator 401 changes and the ion conducting actuator 401 is displaced. The connecting member 403 made of a magnetic body connected to the ion conducting actuator 401, in a state of no magnetic power, moves the drive shaft 104 along the groove of the drive shaft hole 104, to one end portion of the drive shaft hole 104. The light controlling unit 301 rotates around the rotating shaft 203 as a center.

Further, the drive shaft 304 moves to the end portion of the drive shaft hole 104, and the light controlling unit 301 stops at the second stationary position which is a position retracted from the first aperture 102 formed in the first substrate 101. At this time, the supply of the electric power to the ion conducting actuator is stopped according to the stoppage. Moreover, the supply of the electric power to the coil of the magnetic body 801 is also stopped. By doing so, the connecting member 403 made of a magnetic body is held at the second stationary position by the magnetic force of the magnet 802.

Even in the fourth embodiment, similarly as in the first embodiment, the second embodiment, and the third embodiment, the description was made upon letting the initial position of the light controlling unit 301 to be the first stationary position. However, it is similar even when the initial position is the second stationary position.

Moreover, in the fourth embodiment, the description was made by letting the connecting member 403 to be a magnetic body. However, it is possible to achieve a similar effect even when the drive shaft 304 is formed of a magnetic body. Furthermore, it is possible to have a similar effect even when the magnetic body 801 having the coil wound around is removed, and a coil is wound directly around the magnet 802. Moreover, it is possible to have a similar effect even when the connecting member 403 or the drive shaft 304 is formed of a magnet.

As a merit of the fourth embodiment, similarly as a merit of the first embodiment, the second embodiment, and the third embodiment, it is possible to hold the light controlling unit 301 at a predetermined position without supplying the electric power to the ion conducting actuator 401 and the coil. Therefore, it is possible to suppress the electric power consumption, and to reduce a decrease in the amount of displacement of the ion conducting actuator 401 which may be caused due to supplying the electric power all the time.

Moreover, according to the fourth embodiment, unlike the first embodiment and the second embodiment, it is possible to dispose the magnetic body 801 having the coil wound around and the magnet 802 on the rear surface of the substrate 201 on which, no other component is provided. Therefore, it is possible to fix by adhering the magnetic body 801 and the magnet 802 comparatively easily. Moreover, similarly as the second embodiment and the third embodiment, it is possible to have a wide space on the first substrate, and there is an increase in the degree of freedom of designing such as an arrangement of the actuator.

Moreover, in the fourth embodiment, at the time of moving the connecting member 403 by supplying the electric power to the ion conducting actuator 401, the magnetic force of the magnet 802 is negated by passing the electric current through the coil of the magnetic body 801. Accordingly, a friction which occurs due to the magnetic force when the connecting member 403 moves is ceased, and it is possible to move more smoothly than in the third embodiment. Moreover, when the light controlling unit has moved to the first stationary position or the second stationary position, by stopping the electric current, it is possible to stop the light controlling unit at that position by the magnetic force of the magnet.

As it has been described above, the light controlling apparatus according to the present invention is useful in a small-size optical apparatus such as a portable equipment and a micro videoscope having an image pickup function, and in particular, is suitable for a light controlling apparatus which carries out a precise position control.

In the light controlling apparatus according to the present invention, since it is possible to hold the light controlling unit at a predetermined position without supplying the electric power continuously, a time for which the electric power is supplied to the ion conducting actuator is shortened. Consequently, there is shown an effect that it is possible to provide a light controlling apparatus which is capable of suppressing the electric power consumption, and simultaneously avoiding a decrease in an amount of displacement of the ion conducting actuator, while carrying out a precise position control of an optical element.

What is claimed is:

1. A light controlling apparatus comprising:
a substrate in which, an aperture is formed;
a light controlling unit in which, another aperture is formed; and
a ion conducting actuator as a driving source, wherein
the aperture formed in the substrate and the aperture formed in the light controlling unit are switched by moving the light controlling unit to a first stationary position which overlaps with a position of the aperture formed in the substrate, and a second stationary position which is a position retracted from the position of the aperture formed in the substrate, by changing a shape of the ion conducting actuator by supplying an electric power to the ion conducting actuator, and further comprising:
a magnet, wherein
when the light controlling unit has moved to one of the first stationary position and the second stationary position, the power supply to the ion conducting actuator is stopped, and by a magnetic force of the magnet, the light controlling unit is held at one of the first stationary position and the second stationary position.

2. The light controlling apparatus according to claim 1, wherein the ion conducting actuator has a circular arc shape, and the light controlling unit is displaced by changing a chord length of the ion conducting actuator by supplying the electric power to the ion conducting actuator.

3. The light controlling apparatus according to claim 2, wherein when the light controlling unit is being displaced, the magnet serves as a stopper which stops the light controlling unit at one of the first stationary position and the second stationary position.

4. The light controlling apparatus according to claim 3, wherein
at least one of a drive shaft of the light controlling unit and a connecting member coupled with the ion conducting actuator is formed of a magnetic body, and
a pair of magnets is disposed near both end portions of a range of movement of the drive shaft and the connecting member coupled with the ion conducting actuator, and
when the light controlling unit has moved to one of the first stationary position and the second stationary position, the drive shaft of the light controlling unit and the connecting member are held at that stationary position by a magnetic force of one of the pair of magnets.

5. The light controlling apparatus according to claim 3, wherein
the light controlling unit is formed of a magnetic body, and a pair of magnets is disposed near both end portions of a range of movement of the light controlling unit, and
when the light controlling unit has stopped at one of the first stationary position and the second stationary position, the light controlling unit formed of the magnetic body is held at that stationary position by a magnetic force of one of the pair of magnets.

6. The light controlling apparatus according to claim 1, wherein
at least one of the light controlling unit, the drive shaft, and the connecting member coupled with the ion conducting actuator is formed of a magnetic body, and
a magnet in a form of a thin plate is disposed to be facing the magnetic body, leaving a gap in a direction of an optical axis of the light controlling apparatus, and
the light controlling unit is displaced by a displacement of the ion conducting actuator, and
when the electric power is not being supplied to the ion conducting actuator, the position of the light controlling unit is held resisting a restoring force of the ion conducting actuator, by a magnetic force of the magnetic body and the magnet in the form of a thin plate.

7. The light controlling apparatus according to claim 1, wherein
at least one of the light controlling unit, the drive shaft, and the connecting member coupled with the ion conducting actuator is formed of a first magnetic body, and
a magnet in a form of a thin plate is disposed via a second magnetic body around which a coil is wound, facing the first magnetic body, leaving a gap in a direction of an optical axis of the light controlling apparatus, and
when the light controlling unit is displaced, an electric current in a direction negating the magnetic power of the magnet in the form of a thin plate is passed through the coil, and when the light controlling unit is stationary, the position of the light controlling unit is held resisting a restoring force of the ion conducting actuator, by a magnetic force of the first magnetic body and the magnet in the form of a thin plate.
